(19) United States
(12) Patent Application Publication
(10) Pub. No.: US 2014/0120390 A1
(43) Pub. Date: May 1, 2014

(54) BATTERY CELL ASSEMBLY AND METHOD FOR MANUFACTURING A COOLING FIN FOR THE BATTERY CELL ASSEMBLY

(71) Applicant: LG CHEM, LTD., Seoul (KR)

(72) Inventors: Robert Merriman, Shelby Township, MI (US); Michael Nielson, Royal Oak, MI (US); Igor Isayev, Farmington Hills, MI (US); Satish Ketkar, Troy, MI (US)

(73) Assignee: LG CHEM, LTD., Seoul (KR)

(21) Appl. No.: 13/665,204

(22) Filed: Oct. 31, 2012

(51) Int. Cl. H01M 10/50

(52) U.S. Cl. 429/72; 156/60

(57) ABSTRACT

A battery cell assembly is provided. The assembly includes a cooling fin having a tube and a flexible thermally conductive sheet disposed on the tube. The tube has first, second, and third tube portions. The first and second tube portions are substantially perpendicular to one another. The third tube portion is substantially perpendicular to the first and second tube portions and extends between the first and second tube portions. The sheet is coupled to at least the first and second tube portions and has a first sheet portion extending between the first and second tube portions. The assembly further includes a battery cell disposed against the first sheet portion of the sheet of the cooling fin.

### BACKGROUND

A metal cooling plate has been disposed against a battery cell to cool the battery cell. However, the inventors have recognized that a side of the metal cooling plate may have an abrasive residue formed thereon which can undesirably rub against an adjacent battery cell.

Accordingly, the inventors herein have recognized a need for an improved battery cell assembly and a method for manufacturing a cooling fin in the battery cell assembly that minimizes and/or eliminates the above-mentioned deficiency.

### SUMMARY

A battery cell assembly in accordance with an exemplary embodiment is provided. The battery cell assembly includes a cooling fin having a tube and a flexible thermally conductive sheet disposed on the tube. The tube has first, second, and third tube portions fluidly communicating with one another. The first and second tube portions are substantially parallel to one another. The third tube portion is substantially perpendicular to the first and second tube portions and extends between the first and second tube portions. The flexible thermally conductive sheet is coupled to at least the first and second tube portions and has a first sheet portion extending between the first and second tube portions. The battery cell assembly further includes a battery cell disposed against the first sheet portion of the flexible thermally conductive sheet of the cooling fin.

A method for manufacturing a cooling fin of a battery cell assembly in accordance with another exemplary embodiment is provided. The method includes providing a tube having at least first, second, and third tube portions fluidly communicating with one another. The first and second tube portions are substantially parallel to one another. The third tube portion is substantially perpendicular to the first and second tube portions and extends between the first and second tube portions. The method further includes providing a flexible thermally conductive sheet having first, second, and third coupling portions, and first, second, third, and fourth sheet portions. The method further includes coupling the first coupling portion around an outer surface of the first tube portion utilizing the adhesive layer, and coupling the second coupling portion around an outer surface of the second tube portion utilizing the adhesive layer, such that the first sheet portion extends between the first and second tube portions. The method further includes coupling the third coupling portion around an outer surface of the third tube portion utilizing the adhesive layer. The method further includes coupling the second, third, and fourth sheet portions to the first sheet portion utilizing the adhesive layer.

### BRIEF DESCRIPTION OF THE DRAWINGS

FIG. 1 is a schematic of a battery cell assembly in accordance with an exemplary embodiment;

FIG. 2 is an exploded view of the battery cell assembly of FIG. 1;

FIG. 3 is another schematic of the battery cell assembly of FIG. 1;

FIG. 4 is a schematic of a cooling fin utilized in the battery cell assembly of FIG. 1;

FIG. 5 is a schematic of a tube utilized in the cooling fin of FIG. 4;

FIG. 6 is a schematic of a flexible thermally conductive sheet utilized in the cooling fin of FIG. 4;

FIG. 7 is a cross-sectional view of a portion of the cooling fin of FIG. 4;

FIG. 8 is a schematic of a portion of the cooling fin of FIG. 4;

FIG. 9 is a cross-sectional schematic of a portion of the cooling fin of FIG. 4; and

FIG. 10 is a flowchart of a method for manufacturing the cooling fin of FIG. 4 in accordance with another exemplary embodiment.

### DETAILED DESCRIPTION

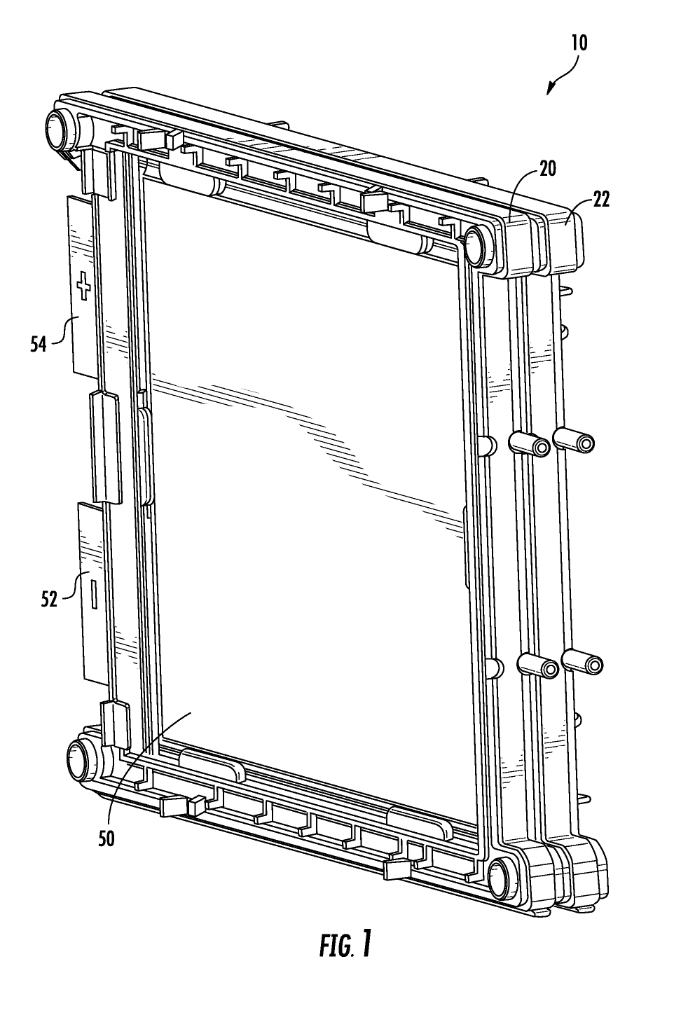

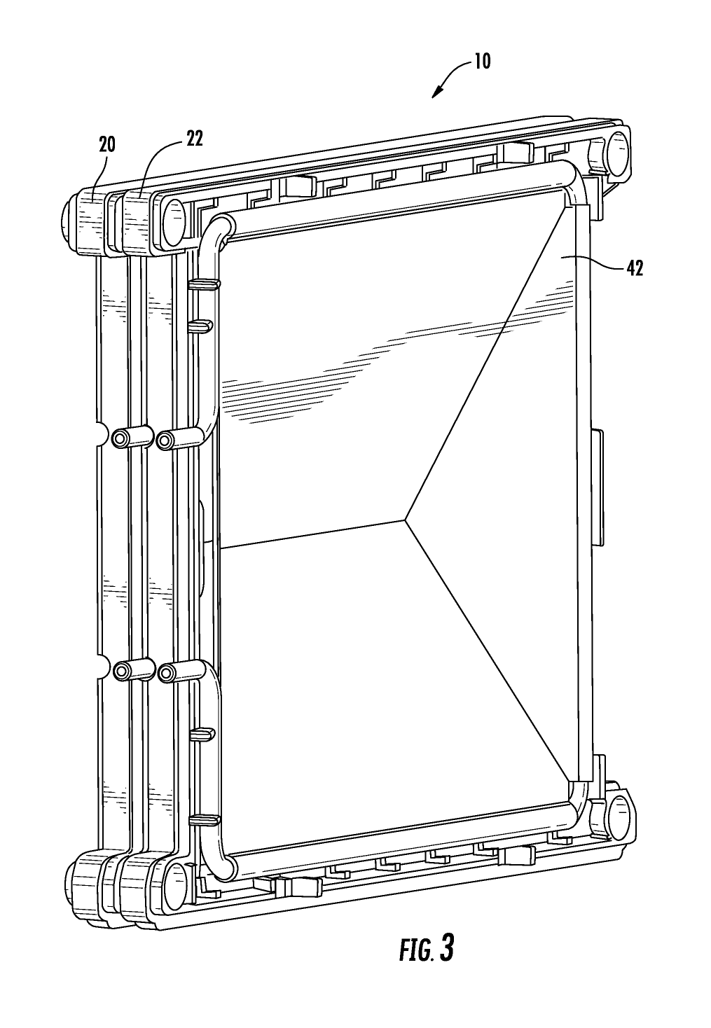

Referring to FIGS. 1-3, a battery cell assembly 10 in accordance with an exemplary embodiment is provided. The battery cell assembly 10 includes rectangular ring-shaped frame members 20, 22, battery cells 30, 32, and cooling fins 40, 42. An advantage of the battery cell assembly 10 is that the assembly 10 utilizes a cooling fin 40 having a flexible thermally conductive sheet 84 which is easily manufactured and has excellent thermal characteristics for conducting heat energy from the battery cells to a tube 82 of the cooling fin 40.

The rectangular ring-shaped frame members 20, 22 are configured to be coupled together to hold the battery cells 30, 32 and the cooling fin 40 therebetween. In one exemplary embodiment, the rectangular ring-shaped frame members 20, 22 are constructed of plastic. However, in alternative embodiments, the rectangular ring-shaped frame members 20, 22 could be constructed of other materials known to those skilled in the art.

The battery cells 30, 32 are each configured to generate an operational voltage. In one exemplary embodiment, each of the battery cells 30, 32 are pouch-type lithium-ion battery cells. Of course, other types of battery cells known to those skilled in the art could be utilized. Also, in an exemplary embodiment, the battery cells 30, 32 are electrically coupled in series to one another.

The battery cell 30 includes a rectangular-shaped pouch 50 and electrodes 52, 54 extending from the pouch 50. The battery cell 30 is disposed between the rectangular ring-shaped frame member 20 and the cooling fin 40.

The battery cell 32 has an identical structure as the battery cell 30. The battery cell 32 is disposed between the rectangular ring-shaped frame member 22 and the cooling fin 40.

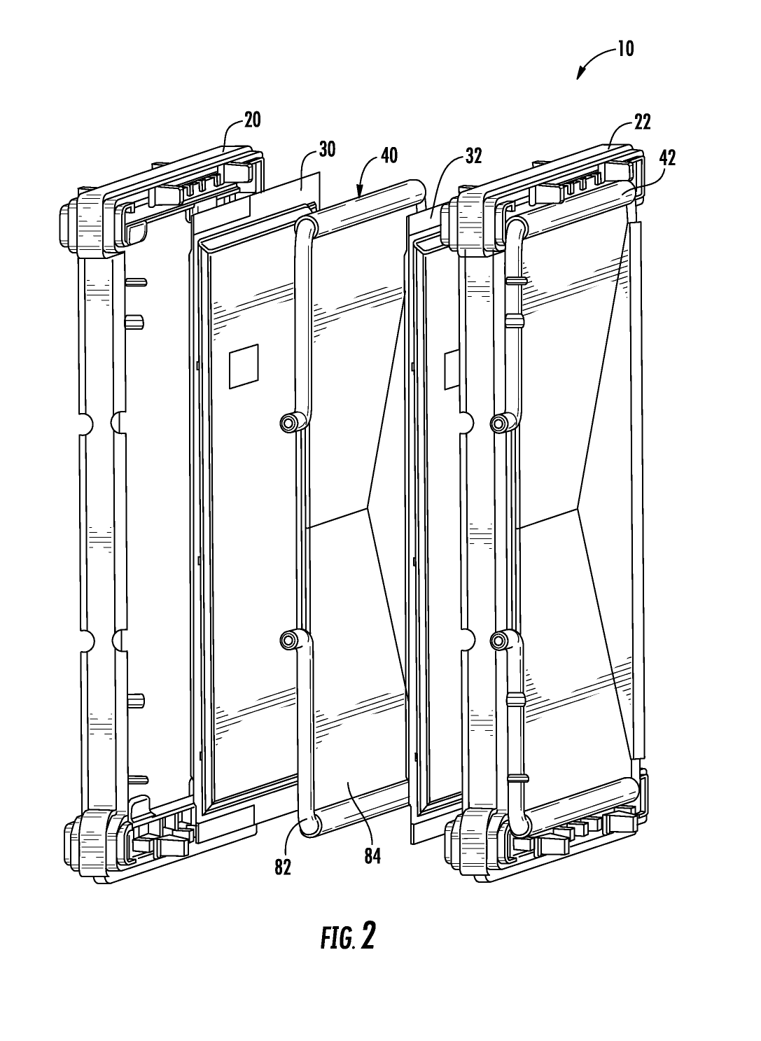

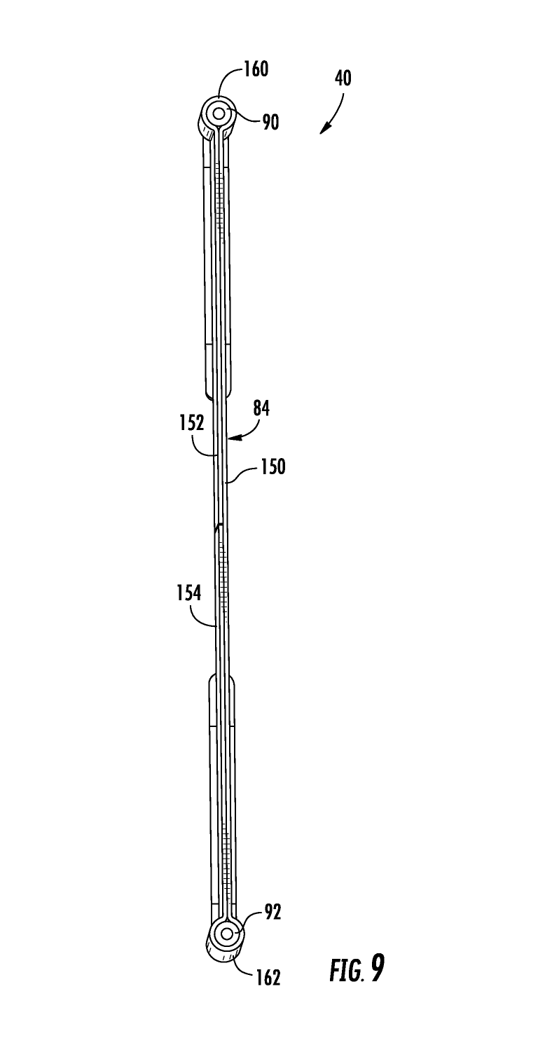

Referring to FIGS. 2-8, the cooling fin 40 is disposed between the battery cells 30, 32 and is configured to transfer heat energy from the battery cells 30, 32 to a refrigerant or a liquid flowing through the cooling fin 40 to cool the battery cells 30, 32. The cooling fin 40 includes a tube 82 and a flexible thermally conductive sheet 84.

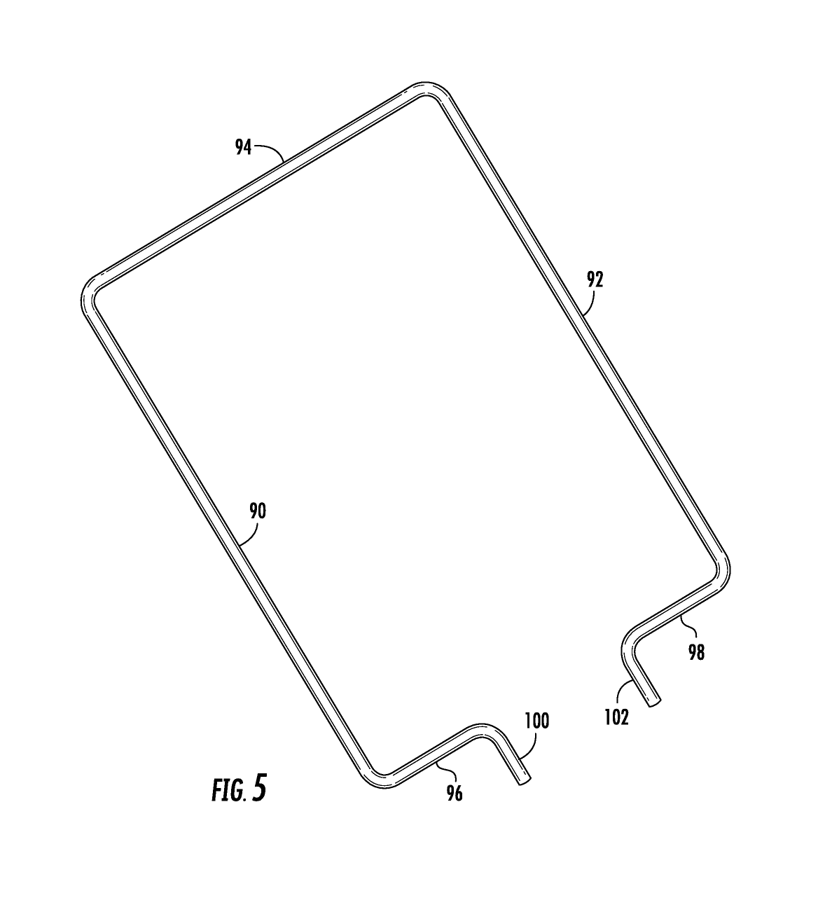

Referring to FIG. 5, the tube 82 is configured to transfer at least a portion of the heat energy to a liquid or a refrigerant flowing through the tube 82. The tube 82 includes a first tube portion 90, a second tube portion 92, a third tube portion 94, a fourth tube portion 96, a fifth tube portion 98, the sixth tube portion 100, and a seventh tube portion 102 that fluidly communicate with one another. The first and second tube portions and 90, 92 are substantially parallel to one another. The third tube portion 94 is substantially perpendicular to the first and second tube portions 90, 92 and extends between the first and second tube portions 90, 92. The fourth and fifth tube portions 96, 98 extend from the first and second tube portions 90, 92, respectively, and are substantially perpendicular to the first and second tube portions 90, 92, respectively. The sixth and seventh tube portions 100, 102 extend from the fourth and fifth tube portions 96, 98, respectively, and are substantially perpendicular to the fourth and fifth tube portions 96, 98, respectively. In one exemplary embodiment, the tube 82 is constructed of aluminum. However, the tube 82 could be constructed of other materials known to those skilled in the art.

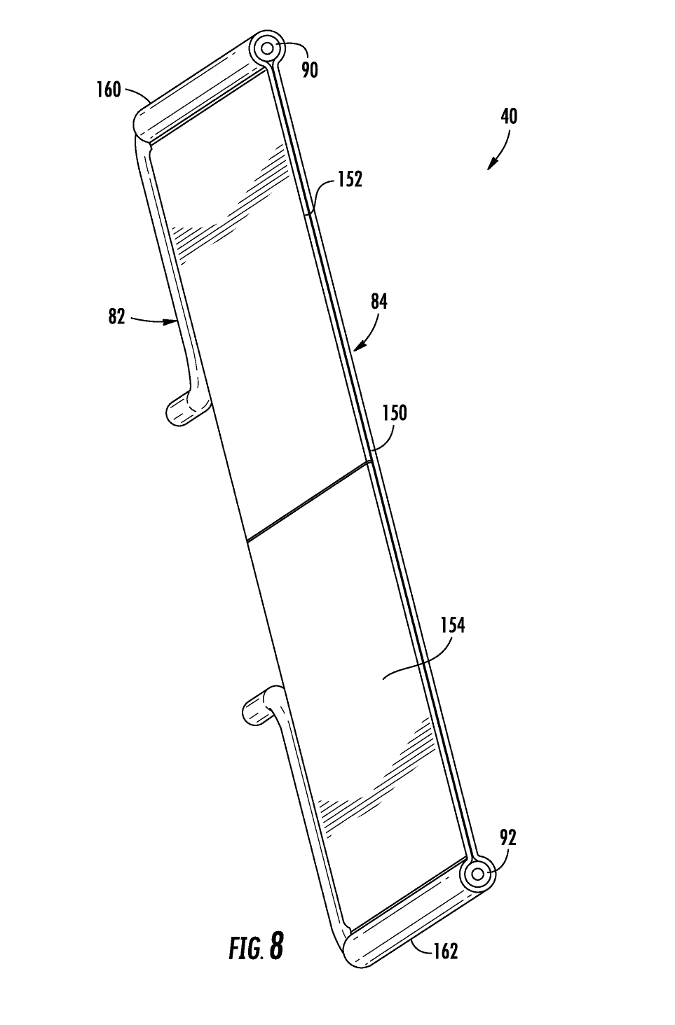

Referring to FIGS. 2 and 6-9, the flexible thermally conductive sheet 84 is configured to transfer heat energy from the battery cells 30, 32 to the tube 82. The flexible thermally conductive sheet 84 includes a flexible layer 130 and an adhesive layer 132 (shown in FIG. 7) disposed on the flexible layer 130.

In one exemplary embodiment, the flexible layer 130 is constructed at least in part utilizing graphite having a thickness in a range of 0.25-0.5 millimeters. Further, the sheet 84 has an in-plane heat conductivity of greater than 200 Watts/meter-Kelvin. Also, in one exemplary embodiment, a side of the flexible layer 130 contacting the battery cell 30 has a roughness average (RA) in a range of 0.8-4.0 micro inches. Of course, in an alternative embodiment, the flexible layer 130 could have an RA less than 0.8 or greater than 4.0. Of course, in alternative embodiments, the flexible layer 130 could have other shapes and sizes known to those skilled in the art. The flexible layer 130 is configured to transfer heat energy from the battery cell 30 to the tube 82. In particular, for example, the flexible layer 130 could comprise “Spreadershield SS-400” manufactured by GrafTech International Holdings Inc.

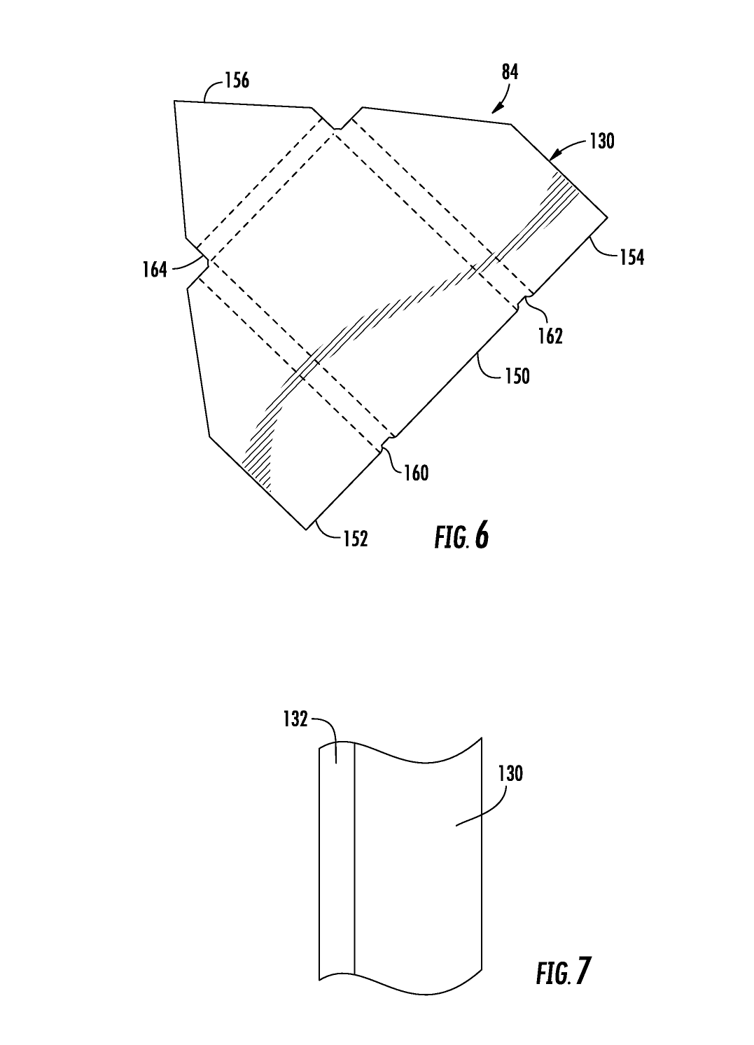

Referring to FIG. 6, in one exemplary embodiment, the flexible layer 130 includes a first sheet portion 150, a second sheet portion 152, a third sheet portion 154, a fourth sheet portion 156, a first coupling portion 160, a second coupling portion 162, and a third coupling portion 164. The first coupling portion 160 is disposed between the first sheet portion 150 and the second sheet portion 152. The second coupling portion 162 is disposed between the first sheet portion 150 and the third sheet portion 154. The third coupling portion 164 is disposed between the first sheet portion 150 and the fourth sheet portion 156.

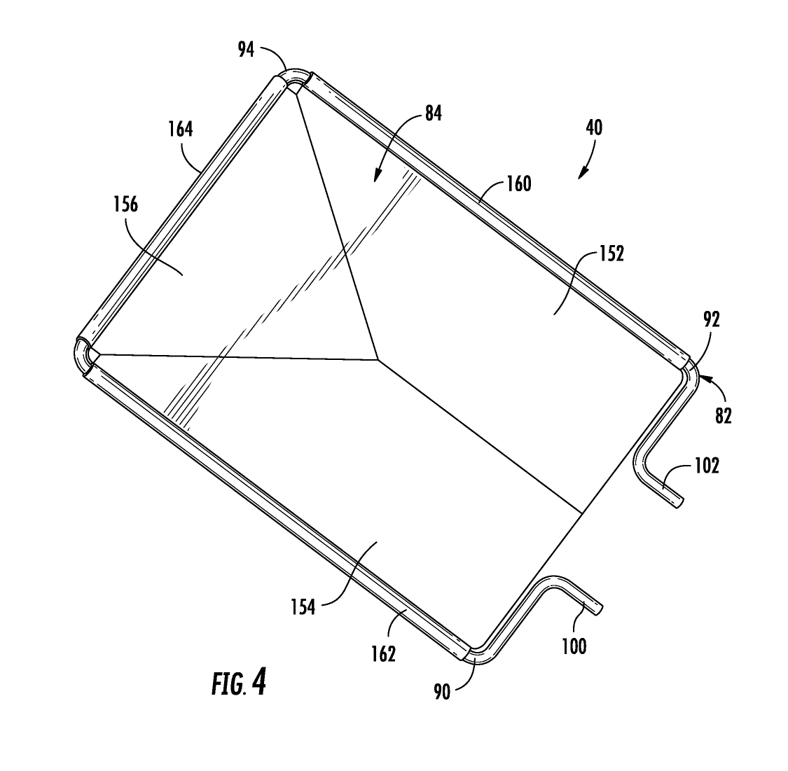

Referring to FIGS. 4-9, during installation of the flexible thermally conductive sheet 82 on the tube 84, the first and second coupling portions 160, 162 are disposed on and around substantially the entire first and second outer surfaces, respectively, of the first and second tube portions 90, 92, respectively, utilizing the adhesive layer 132. The first sheet portion 150 is coupled to the first and second coupling portions 160, 162 and extends between the first and second tube portions 90, 92. The first sheet portion 150 is sized to be disposed against a generally rectangular-shaped side surface of the battery cell 30 and to cover substantially the entire generally rectangular-shaped side surface of the battery cell 30. The second sheet portion 152 extends from the first coupling portion 160 and the first tube portion 90 and is coupled to the first sheet portion 150 utilizing the adhesive layer 132. The third sheet portion 154 extends from the second coupling portion 162 and the second tube portion 92 and is coupled to the first sheet portion 150 utilizing the adhesive layer 132. The third coupling portion 164 is disposed on and around substantially an entire outer surface of the third tube portion 94 utilizing the adhesive layer 132. The fourth sheet portion 156 is coupled to the third coupling portion 164 extends from the third tube portion 94 and is coupled to the first sheet portion 150 utilizing the adhesive layer 132.

Referring to FIG. 7, in one exemplary embodiment, the adhesive layer 132 is a pressure sensitive adhesive disposed on one side of the flexible layer 130.

Referring to FIG. 2, the cooling fin 42 has an identical structure as the structure of the cooling fin 40. The cooling fin 42 is disposed on the rectangular ring-shaped frame number 22 and against the battery cell 32 and extracts heat energy from the battery cell 32 to a refrigerant or a liquid flowing through the cooling fin 42 to cool the battery cell 32.

Referring to FIGS. 2, 4 and 5, during operation, a refrigerant or a liquid enters the sixth tube portion 100 from a source device and flows through the fourth tube portion 96, the first tube portion 90, the third tube portion 94, the second tube portion 92, the fifth tube portion 98, and the seventh tube portion 102 and exits the seventh tube portion 102 to a receiving device. Heat energy generated by the battery cell 30 is conducted through the flexible thermally conductive sheet 84 to the tube 82. Further, heat energy generated by the battery cell 32 is conducted through the flexible thermally conductive sheet 84 to the tube 82. Further, the heat energy in the tube 82 is conducted into the refrigerant or the liquid flowing through the tube 82. Thus, the refrigerant or the liquid flowing through the tube 82 absorbs the heat energy from the battery cells 30, 32 to reduce a temperature of the battery cell 30, 32.

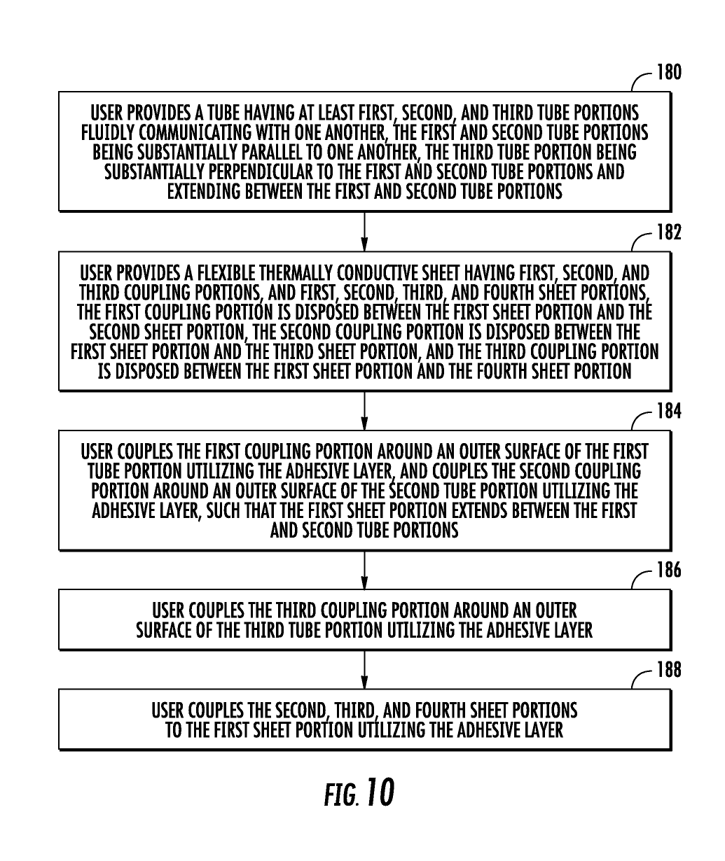

Referring to FIGS. 4-10, a flowchart of a method for manufacturing the cooling fin 40 in accordance with another exemplary embodiment will now be explained.

At step 180, the user provides the tube 82 having at least first, second, and third tube portions 90, 92, 94 fluidly communicating with one another. The first and second tube portions 90, 92 are substantially parallel to one another. The third tube portion 94 is substantially perpendicular to the first and second tube portions 90, 92 and extends between the first and second tube portions 90, 92. After step 180, the method advances to step 182.

At step 182, the user provides the flexible thermally conductive sheet 84 having first, second, and third coupling portions 160, 162, 164, and first, second, third, and fourth sheet portions 150, 152, 154, 156. The first coupling portion 160 is disposed between the first sheet portion 150 and the second sheet portion 152. The second coupling portion 162 is disposed between the first sheet portion 150 and the third sheet portion 154, and the third coupling portion 164 is disposed between the first sheet portion 150 and the fourth sheet portion 156. After step 182, the method advances to step 184.

At step 184, the user couples the first coupling portion 160 around an outer surface of the first tube portion 90 utilizing the adhesive layer 132, and couples the second coupling portion 162 around an outer surface of the second tube portion 92 utilizing the adhesive layer 132, such that the first sheet portion 150 extends between the first and second tube portions 90, 92. After step 184, the method advances to step 186.

At step 186, the user couples the third coupling portion 164 around an outer surface of the third tube portion 94 utilizing the adhesive layer 132. After step 186, the method advances to step 188.

At step 188, the user couples the second, third, and fourth sheet portions 152, 154, 156 to the first sheet portion 150 utilizing the adhesive layer 132.

The battery cell assembly 10 and the method for manufacturing the cooling fin 40 provide a substantial advantage over other battery cell assemblies and methods. In particular, the battery cell assembly 10 and the method provide a technical effect of utilizing a cooling fin 40 with a flexible thermally conductive sheet 84 to extract heat energy from battery cells.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

What is claimed is:

1. A battery cell assembly, comprising:
a cooling fin having a tube and a flexible thermally conductive sheet disposed on the tube;
the tube having first, second, and third tube portions fluidly communicating with one another, the first and second tube portions being substantially parallel to one another, the third tube portion being substantially perpendicular to the first and second tube portions and extending between the first and second tube portions;
the flexible thermally conductive sheet being coupled to at least the first and second tube portions and having a first sheet portion extending between the first and second tube portions; and
a battery cell disposed against the first sheet portion of the flexible thermally conductive sheet of the cooling fin.

2. The battery cell assembly of claim 1, wherein the flexible thermally conductive sheet is configured to transfer heat energy from the battery cell to the tube.

3. The battery cell assembly of claim 2, wherein the tube is configured to transfer at least a portion of the heat energy to a liquid or a refrigerant flowing through the tube.

4. The battery cell assembly of claim 1, wherein the flexible thermally conductive sheet is further coupled to the third tube portion.

5. The battery cell assembly of claim 1, wherein the flexible thermally conductive sheet includes an adhesive layer disposed thereon.

6. The battery cell assembly of claim 5, wherein the flexible thermally conductive sheet is disposed around an outer surface of the first tube portion and is coupled to the first tube portion utilizing the adhesive layer.

7. The battery cell assembly of claim 6, wherein the flexible thermally conductive sheet is further disposed around an outer surface of the second tube portion and is coupled to the second tube portion utilizing the adhesive layer.

8. The battery cell assembly of claim 7, wherein the flexible thermally conductive sheet further includes second and third sheet portions extending from the first and second tube portions, respectively, that are coupled to the first sheet portion utilizing the adhesive layer.

9. The battery cell assembly of claim 8, wherein the flexible thermally conductive sheet is further disposed around an outer surface of the third tube portion and is coupled to the third tube portion utilizing the adhesive layer.

10. The battery cell assembly of claim 9, wherein the flexible thermally conductive sheet further includes a fourth sheet portion that extends from the third tube portion and is coupled to the first sheet portion utilizing the adhesive layer.

11. The battery cell assembly of claim 6, wherein the flexible thermally conductive sheet is disposed around substantially an entire outer surface of the first tube portion.

12. The battery cell assembly of claim 1, wherein the tube is an aluminum tube.

13. The battery cell assembly of claim 1, wherein the first sheet portion is sized to cover substantially an entire generally rectangular-shaped side surface of the battery cell.

14. The battery cell assembly of claim 1, wherein the flexible thermally conductive sheet has a roughness average in a range of 0.8-4.0 micro-inches.

15. The battery cell assembly of claim 1, further comprising first and second rectangular-shaped frame members, the cooling fin and the battery cell being disposed between the first and second rectangular-shaped frame members.

16. The battery cell assembly of claim 1, further comprising fourth and fifth tube portions extending from the first and second tube portions, respectively, the fourth and fifth tube portions being substantially perpendicular to the first and second tube portions, respectively.

17. The battery cell assembly of claim 16, further comprising sixth and seventh tube portions extending from the fourth and fifth tube portions, respectively, the sixth and seventh tube portions being substantially perpendicular to the fourth and fifth tube portions, respectively.

18. A method for manufacturing a cooling fin of a battery cell assembly, comprising:
providing a tube having at least first, second, and third tube portions fluidly communicating with one another, the first and second tube portions being substantially parallel to one another, the third tube portion being substantially perpendicular to the first and second tube portions and extending between the first and second tube portions;
providing a flexible thermally conductive sheet having first, second, and third coupling portions, and first, second, third, and fourth sheet portions;
coupling the first coupling portion around an outer surface of the first tube portion utilizing the adhesive layer, and coupling the second coupling portion around an outer surface of the second tube portion utilizing the adhesive layer, such that the first sheet portion extends between the first and second tube portions;
coupling the third coupling portion around an outer surface of the third tube portion utilizing the adhesive layer;
coupling the second, third, and fourth sheet portions to the first sheet portion utilizing the adhesive layer.

19. The method of claim 18, wherein the first coupling portion is disposed between the first sheet portion and the second sheet portion, the second coupling portion is disposed between the first sheet portion and the third sheet portion, and the third coupling portion is disposed between the first sheet portion and the fourth sheet portion.
